(19) United States
(12) Patent Application Publication
(10) Pub. No.: US 2004/0252847 A1
(43) Pub. Date: Dec. 16, 2004

(54) Sound system with passive speaker and proximity antenna

(76) Inventor: Bruce A. Bassett, Sugar Land, TX (US)

Correspondence Address: Bruce A. Bassett, 3007 Prairie Place, Sugar Land, TX, 77479, US

(21) Appl. No.: 10/703,979

(22) Filed: Nov. 7, 2003

Related U.S. Application Data
(60) Provisional application No. 60/424,512, filed on Nov. 7, 2002.

(51) Int. Cl. H04B 3/00; H04B 5/00

(52) U.S. Cl. 381/77; 381/79

(57) ABSTRACT

The present invention is a sound delivery system for use to deliver live and pre-recorded sound, including stories, music, soothing background sounds, radio, streaming audio, television, from a person located anywhere from near or remote distances through audio transport networks, through a proximity antenna pad device, to a pillow, or like headrest, or stuffed object including stuffed animals to a person's head located adjacent to the pillow or like stuffed object. The pillow sound delivery system comprises an audio transport network and a pillow, or like stuffed object, with a passive pillow speaker receiver inside the pillow, and a proximity antenna device outside the pillow to transmit from the audio transport network to the pillow speaker receiver.

### REFERENCE TO RELATED APPLICATIONS

This application claims priority to U.S. Provisional Patent Application No. 60/424512, entitled “PILLOW SPEAKER SYSTEM APPARATUS AND METHOD”, filed Nov. 7, 2002.

### BACKGROUND OF THE INVENTION

The present invention relates to sound delivery systems, and more particularly to speaker sound systems installed in soft devices used for comfort and resting, and audio transport networks to transport audio to the speaker sound systems installed in soft devices.

Since increasing numbers of family members or other persons are being separated (due to business travel, divorce, or relocation), it is important to have methods and tools for children and parents or loved ones to be able to share, read or sing bedtime/wakeup stories or songs from remote places. The present invention relates not only to the speaker sound system installed in soft devices used for comfort, with an accompanying proximity antenna which requires child or user to stay in bed or the desired location, but also relates to the method and systems for enabling friends and loved ones located in near or remote places to deliver live and pre-recorded audio content for the child or loved one while the child or loved one is going to bed or waking up.

Pillows and headrests having speakers or receiving devices incorporated therein are not new in the art; nor are the methods of manufacturing such pillow speaker systems. The wide variety of such pillow devices is partially manifest in the different ornamental designs disclosed in U.S. Pat. No. D311,472 issued in October 1990 to Giles and U.S. Pat. No. D338,798 issued in August 1993 to Grzybinski. The design of the '472 patent does not conform to the common pillow form and one is unable to use traditional pillow linen. The '802 patent uses a music box sound generation system and is unable to transmit the sound generated and controlled by a more traditional sound generation device, like radio, television, discs or tapes.

An early example of a pillow sound system is U.S. Pat. No. 2,512,641 issued to Halstead on Apr. 28, 1947. The '641 patent discloses a pillow radio receiver which can receive pre-set radio frequencies through a circuit which includes a flexible receiving antenna located on the periphery of the pillow. This pillow design is made of a front pad and a rear pad composed of a molded porous rubber compound having a multiplicity of air cells and sealed together with rubber cement to retain flexibility. Further, the pads contain chambers in which to house different circuitry components. The creation of these pads can be costly while yielding a pillow structure uncommon to the traditional soft fibrous pillows. Moreover, having additional circuitry located in the pillow and hard controls located on the side of the pillow can cause undesirable experiences in comfort and safety during pillow-fights. Because this design receives radio signals from radio transmissions, this design would allow the user to move the pillow around the room and would not restrict use of the audio functions of the pillow to locations on or near the bed.

As seen in the prior art, there is no provision for a passive pillow or stuffed animal wherein the soft object is designed around the common bedtime experience which may comprise such features as a pillow having no wires going into the pillow, a pillow having no controls being accessed inside or located on the side of the pillow (a safety concern), or a pillow that is sealed and does not need to be opened for maintenance (replacing or charging batteries, for example). Nor in the prior art is there provision for a pillow to be located next to the proximity antenna, which allows the parent to place said proximity antenna in the location where they want the child to remain (for example in bed), thus requiring the child to stay in that location with his head on the pillow.

Both packet-switched and circuit-switched audio and communication networks for transporting live and pre-recorded audio are known. For example, U.S. Pat. No.6,434,621 discloses an audio transport network with a one-to-many web casting model with set times and programming and with many receivers receiving the web cast audio streams simultaneously through a variety of web streaming platforms. Audio streaming enhancing techniques are seen in Patent Application Publication 2002/0129151. A one-to-one communication model through combinations of public switched telephone network (PSTN) and packet switched voice over internet protocol (VOIP) networks are noted in U.S. Pat. Nos. 6,373,817 and 6,507,577 where audio is transported in two-way communication networks with the possibility of storing voice messages for client recall at a later period. However, the audio transport models do not extend to pillows or like soft devices, thus enabling remote persons to connect to the end user child or loved one as they are going to sleep, waking up or resting.

### SUMMARY OF THE INVENTION

The invention comprises a device and methodology for capturing, transporting, and playing audio signals through a normal-type pillow, both real-time and recorded, from someone near or remote to someone laying down, going to sleep or waking up. For example, a remote parent can call from his or her cellular phone to a telephone system wherein they can record a bedtime song or message for their children, and can have the recording played back through the pillow or stuffed doll as the children are going to sleep or waking up.

The apparatus may further comprise a device which motivates a child to go to bed on time and stay in bed with their head on the pillow or like stuffed object. For example, through an auto-bedtime feature the parent can set what time the audio signal should start broadcasting through the pillow so the child must go to bed on time to hear the desired programming. A proximity antenna pad is placed under the mattress pad in the desired location of the pillow. The child is motivated to keep her pillow on her bed and is not allowed to play around the room or she will loose the desired programming. Through the use of volume control, the child will be motivated to keep her head on the pillow to optimize hearing of the desired programming. Thus through various features, the child must get to bed on time, have her pillow on her bed, and her head down on the pillow to hear the desired programming.

The invention may also comprise an auto-wakeup feature wherein the parent or user can set the wakeup time and have the morning message automatically broadcast at a certain time. This enables the parent to record a message during the night to wake the child up with, “Good morning, today is Tuesday. Don't forget you have piano lessons this morning and a math test today, and that mother loves you . . .”

The disclosure also provides for the means for a user or parent to set the play list of content for the child by logging into a remote URL server and collecting the desired content from their private user in-box, private library of past messages, and also the public library of professionally recorded content and then arranging them in desired play list order.

Embodiments may include means wherein the parent can be somewhere in the residence and through a portable microphone be broadcasting real-time to one or all of their children's pillows simultaneously. For example, a mother could be in the kitchen with a portable microphone singing while all the children are listening to her voice through each of their respective pillows.

### BRIEF DESCRIPTION OF DRAWINGS

FIG. 1 is a top plan view of a pillow with a passive speaker system.

FIG. 2 is a side plan view of the pillow of FIG. 1.

FIG. 3 is a top plan view of a pillow having a multiple or stereo speaker system.

FIG. 4 is a top plan view of a pillow having a multiple or stereo speaker system and a plurality of speakers per channel.

FIG. 5 is a top plan view of a passive proximity antenna on a substrate.

FIG. 6 is a perspective view of a bed having a proximity antenna and the pillow of FIG. 1, and further comprising a soft toy or doll containing a passive speaker system.

FIG. 7 is a flow chart of a process for distribution of professionally created content to a passive speaker system in a toy or a pillow.

FIG. 8 is a flow chart of a process for distribution of personalized content created through a PSTN network, a VOIP network, or a remote device to a passive speaker system in a toy or a pillow.

FIG. 9 is a block diagram of a system architecture for accessing and managing content from the client devices and software.

FIG. 10 is a block diagram of the system architecture of FIG. 9 further comprising a personal computer remote from a proximity antenna.

FIG. 11 is a block diagram of a system having an audio transport path from input source to an end pillow listener.

FIG. 12 is a block diagram of a system having a plurality of receivers and pillows or soft toys containing passive speaker systems.

FIG. 13 is a block diagram of the system of FIG. 14 having a plurality of transmitters.

FIG. 14 is a block diagram of a system having a real-time audio transport path from a portable microphone, PSTN or other source to the end pillow listener.

FIG. 15 is a block diagram of an audio transport path from the publicly published broadcast and playback media to the end pillow listener.

### DETAILED DESCRIPTION

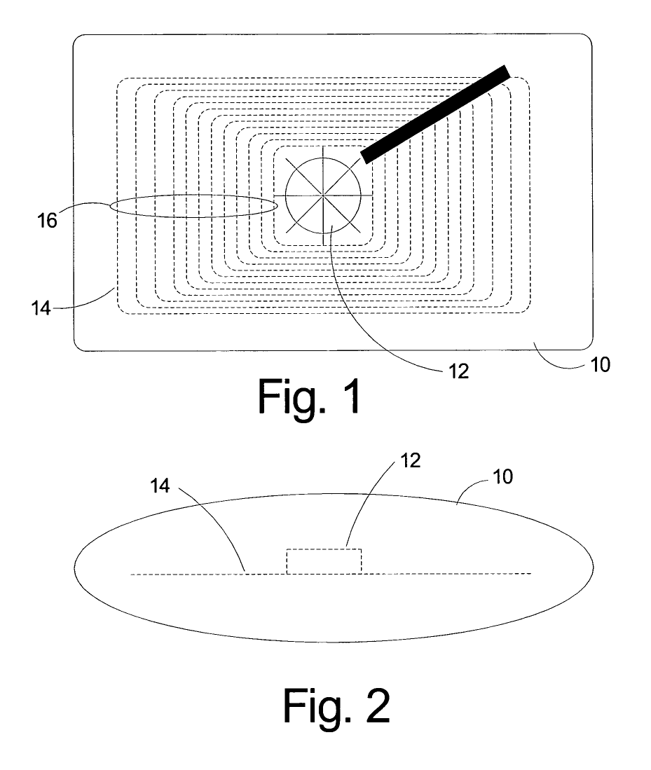

An output device is illustrated in FIG. 1 through FIG. 5. The output device comprises a speaker and a passive receiver antenna connected to said speaker. A proximity antenna may be in electromagnetic communication with said receiver antenna within a designed range.

As seen in FIG. 1 a pillow 10 or soft device contains a speaker 12 and passive receiver antenna 14. The speaker utilized can be any type to meet the desired specific installation and performance characteristics requirements, such as piezo-electric speakers for high impedance matching of circuitry or for small size so as to be undetectable, or traditional magnetic speakers to increase sound quality, or speakers which are designed to be more rugged to environmental requirements to include pillow-fighting or machine washing.

Also seen in FIG. 1, the passive receiver antenna 14 is a wire coil 16. The coil 16 may be made through a variety of means including stitching or sewing a wire in a coil pattern for rugged durability and low detectability, or through circuit boards which can have rigid or flexible substrates to speed production. The coil 16 may also be flat in a planar fashion (only one wire width in a “z” direction) or wires may be stacked on top of each other so as decrease the “x” and “y” dimensions by increasing the “z” dimension to two or more wires. This would be the situation where a smaller doll or stuffed animal would want a small “x” and “y” dimension. The passive receiver antenna can be customized for a multitude of different devices, including but not limited to pillows or headrest, stuffed animals, dolls, including action figures and movie or cartoon figures, or nanny dolls customized for an individual child or family.

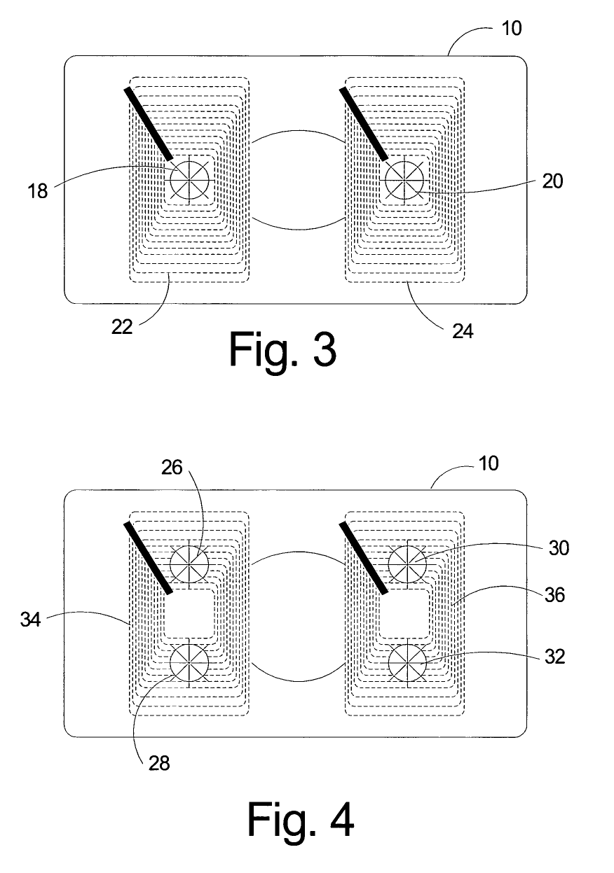

As illustrated in FIG. 3 there can be a plurality of speakers 18, 20 and passive receiver antennas 22, 24 in the pillow 10 or soft object. In addition, as shown in FIG. 4, a plurality of speakers 26, 28 and 30, 32 may be provided for each passive receiver antenna 34 and 36, respectively. This can allow for stereo sounds to be reproduced through the speakers.

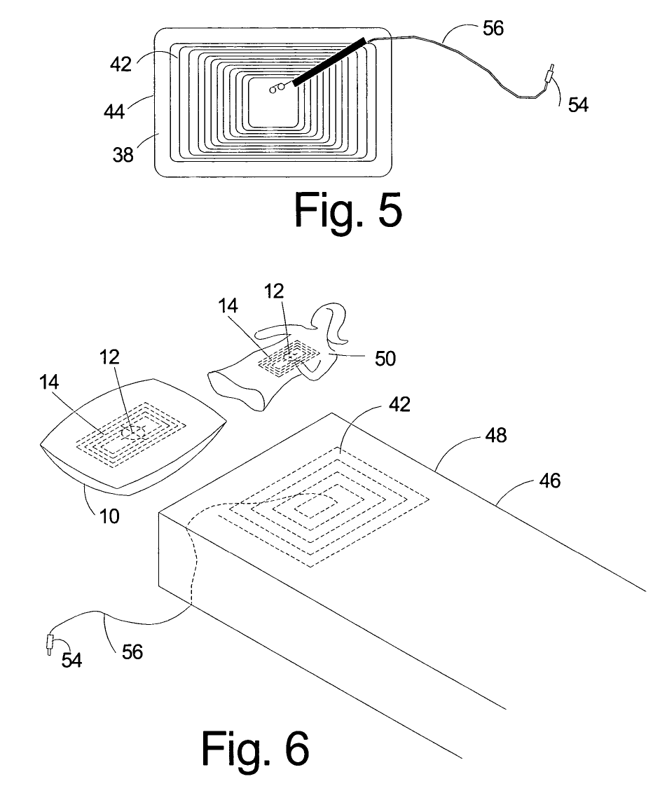

FIG. 5 illustrates one embodiment of a proximity antenna 38 comprising a coil similar to the passive receiver antenna coil 14 installed inside the pillow 10 or soft object. The coil may be made through a variety of means including but not limited to stitching or sewing a wire 42 in a coil pattern into a substrate 44 of material (for example, a cloth or small pad) to be placed underneath a mattress or mattress pad or fitted sheets, or stitching or sewing the wire 42 in a coil pattern directly into a mattress 46 or mattress pad 48 or fitted sheet, as shown in FIG. 6. Further, the substrate 44 may be a circuit board which can comprise a rigid or flexible substrate such as flex-circuitry to be placed underneath the mattress or mattress pad or fitted sheet. The proximity antenna 38 is unobtrusive and will preferably change the bedtime experience very little if at all. A young child or user may never know that a proximity antenna is being used. All the child will need to know is that she should keep her pillow on the bed for the special signal to be received.

The shape of the proximity antenna 38 and conductive materials used in the proximity antenna 38 will affect the shape of the reception envelope in which the passive receiver antenna 14 must be located in order to receive the desired audio signal. For example, in the case where a little child wants the signal to be heard from a multiplicity of devices (a pillow 10, a stuffed animal near the pillow, and a doll 50), then the proximity antenna should be designed large to create a larger reception envelope allowing a multiplicity of devices. In the case where the parent or child would want the signal to be heard from anywhere on top of the bed, then the proximity antenna 42 could be made as large as the entire mattress, thus enabling a large reception envelope in which the soft objects may be moved while still maintaining reception of signal. Because the reception envelope generated by the proximity antenna 42 is limited, if the child wants to hear the desired programming, she has to have her pillow on the bed (as opposed to anywhere in the room).

It also is to be noted that the reception envelope is a function of the signal power being sent to the proximity antenna 42. For example an amplifier including a power source may be at the end of the audio delivery conduit in an audio client device 52 to boost the signal power going into the proximity antenna 42 to create a larger reception envelope. This may allow the proximity antenna 42 to be placed underneath the mattress 46, or allow the pillow 10 or soft object 50 to also travel farther way from the proximity antenna 42. Throughout the reception envelope, the reception performance of the passive antenna 14 will vary based on the shape of the magnetic field caused by the shape of the proximity antenna and signal power levels. By controlling signal power levels, a parent can also determine not only the reception envelope, but also how loud the audio output of the speaker 12 is in the pillow, thus enabling a soft, but audible volume for motivating the child to keep her head down on the pillow to best hear the desired programming.

The proximity antenna further comprises means to connect to an audio delivery conduit. This may be any suitable audio jack connector device 54, including but not limited to traditional headphone or speaker connectors. A cable 56 extending to the connector device may vary to reach the desired audio delivery conduit connection (including lengths to go from room to room).

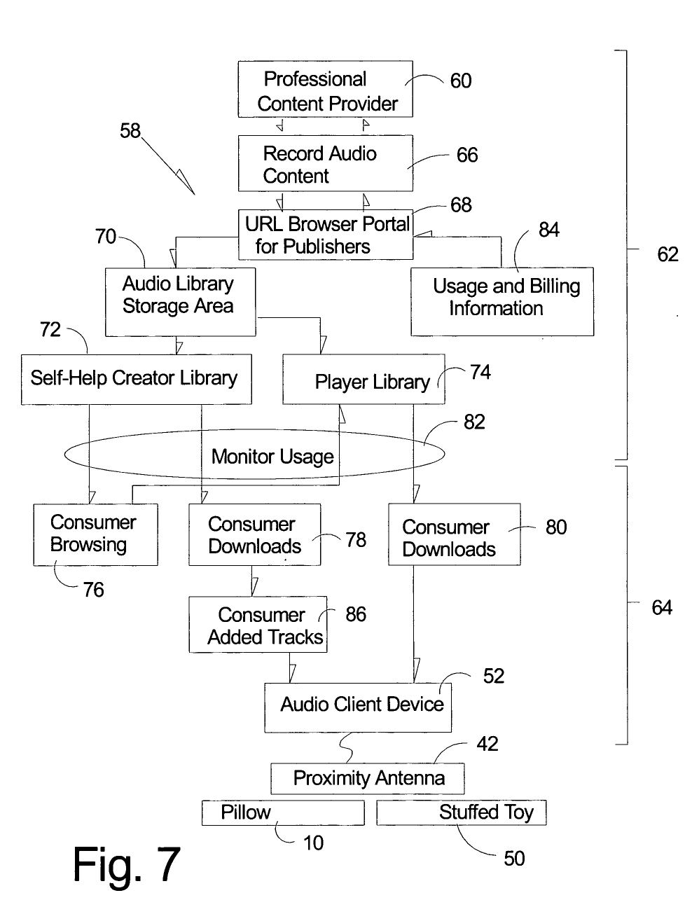

FIG. 7 depicts an end-to-end methodology 58 for transporting audio signals from a professional generator 60 of audio to an end listener through a delivery conduit and output device. The conduit process illustrated contains two main sub-processes: generators posting content 62 into the libraries and consumers browsing and downloading 64 content from the libraries to be sent to the output device.

The professional audio generator 60 can create 66 bedtime, wake-up, or restful audio productions using any combination of songs, stories, soothing sounds or other audio means using recording studios or technologies. After creating the recorded source, the audio may be encoded 68 into a variety of formats for posting or loading on to an Internet server ready for playback on a client device. This posting and managing of content by the generator can be accomplished by logging into the server through means of an internet browser and then deleting and uploading into the their allotted server storage space the audio files they want to have published in their part of the libraries 70 for consumer downloading. This posting automatically updates the files made available to users immediately after the posting process is completed.

There can be several libraries on the server based on genre, religions, hobbies, or interests, or files formats (for different players). While FIG. 7 embodies only two types, it should not be limited to these types of libraries. The Self-Help Creator Library 72 is to provide parents or amateur audio creators the tools needed to complete a professional bed-time, wake-up, or restful audio production through the means of stories and songs with “minus tracks” so that the parent can download the recording programs to record and add their final track of reading or singing to file already with the other tracks all pre-recorded. This could be a karaoke type program wherein the words appear on the computer at the time one is to sing or speak them while the computer is recording the last track and adding 86 it to the other tracks. Upon completion of adding the additional track, the consumer can then store it on the local PC client 52, or send it to other users. The other library depicted in FIG. 7 is the Player Library 74 which includes files ready for download and playback upon demand from the client software, and may include stories, music or other content.

As consumers perform the browsing 76 and downloading 78, 80 of files from the libraries, the server will be gathering 82 usage statistics 84 to determine how many ‘hits’ the files are receiving which can be useful in helping generators 60 optimize their content to achieve higher amounts of downloads, as well as in calculating possible compensation for generators 60.

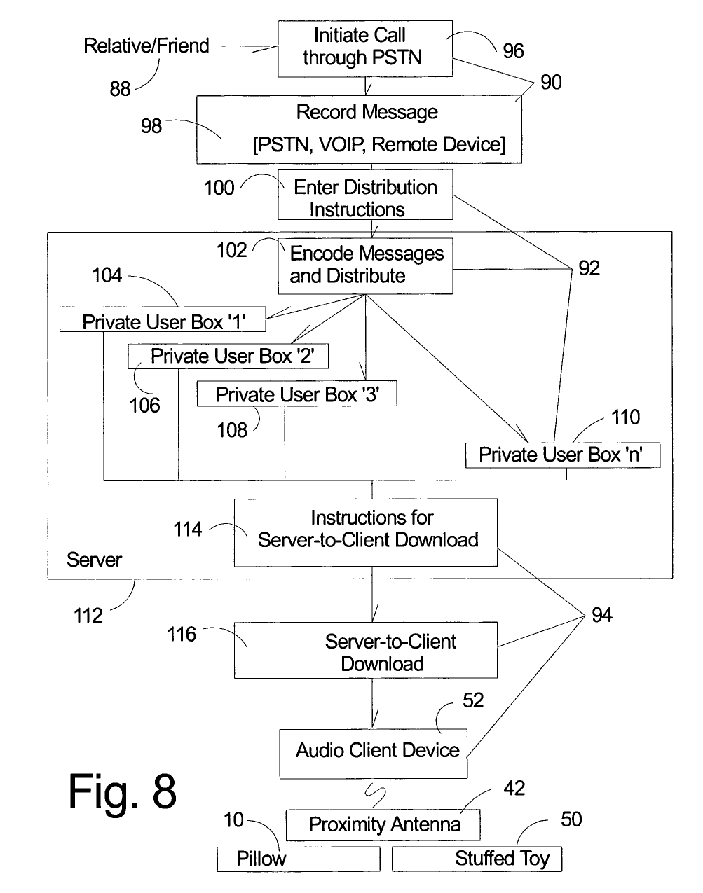

FIG. 8 illustrates transporting audio signals from a personal audio generator 88 such as a friend, relative, or audio therapist to an end listener through a delivery conduit and output device. The conduit process illustrated in FIG. 8 contains three main sub-processes: generators capturing and storing content 90, distributing the content file to one or more private user boxes 92, and consumers or users downloading 94 their content to the client PC device 52 for playback to the output device.

In the FIG. 8, an audio signal is first captured and transported in the public telephone network (PSTN) 96. The front end of the PSTN can be a variety of circuit based switching networks including Plain Old Telephone Service (POTS) with cables or wireless (including cellular) connections to the phone device. The storage 98 of the audio file can be through various storage and encoding means, including but not limited to voice mail recording technologies. After capture the audio file can be converted into which ever format the client device needs for playback to the audio output device.

Upon completing the capture and formatting processes, the file can then be distributed 102 to a plurality of private user boxes on the server. This distribution can be accomplished by a series of key strokes in telephone to give instructions 100 to which user boxes 104, 106, 108, 110 are to receive the audio file. If a particular private box is out of allocated storage memory, a voice or email message may be sent to the personal audio generator 88 informing the personal audio generator 88 of out of memory condition for each private user box in such an overloaded state

It is also envisioned that in the distribution process, the actual audio file may be stored only once on the server 112 and all private user boxes to which the file was to be distributed will only have a “pointer” in the private user box so that when it is selected, a download of the one single file is copied down to the client device and the original file on the server remains for other pointers in other private user boxes. This method would also save storage space on the server.

Upon completing the distribution processes wherein the files are distributed to their respective private user boxes, the consumers or user download process 116 can take place based on the download instructions 114 provided by the user downloading preferences selected. For example a user may select to have her downloads take place each evening at a certain time in a batch process format, just before the end users go to bed. Or one may choose to have another automatic downloads during the night to capture all wake-up files sent for playback as the end users wake up. Another embodiment would be to have downloads take place automatically upon receipt at the server private user box, thus minimizing time the files are stored on the server in the private user box. Another embodiment would be to have the download preferences be set on “download on demand” which will wait to download until manually executed upon the user commands.

Also shown in FIG. 8 is similar embodiment the audio signal is initiated 98 through Voice Over Internet Protocol (VOIP) in lieu of the PSTN. Then the distribution instructions can be entered in through a series of keystrokes from a VOIP ready device, including but not limited to PCs or VOIP telephone.

The audio signal may also be initiated 98 from a PC. This would include an audio content generator 88 creating a file from the Self Help Creator Library 72 (FIG. 7) and then distributing it to the private user boxes on the server 112. For example, a grandmother may create a file and then distribute the message to all her grandchildren around the country. In this embodiment, with the interface device being that of a PC with Internet browser, the means for inputting distribution instructions and maintaining regular distribution lists for easy recall and use is enhanced and made simpler.

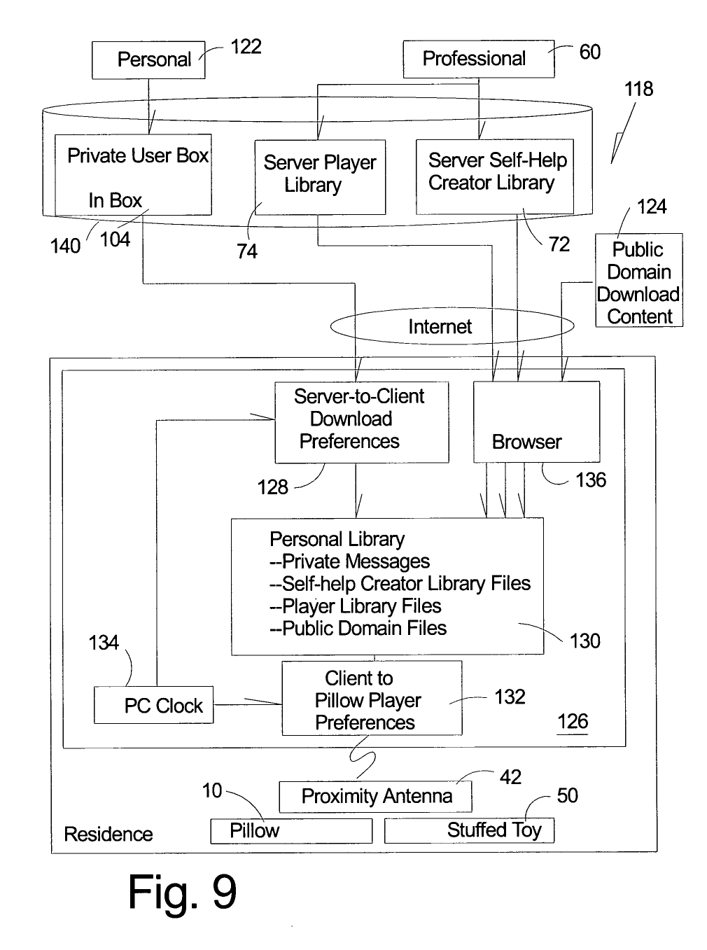

FIG. 9 illustrates end-to-end system network architecture 118 for transporting audio signals from a professional generator 120, personal generator 122 or selected individual such as a parent, family member, or friend, or other public domain media content generator 124, to an end listener through a delivery conduit which includes a PC client device 126 for storing and managing locally on the PC the downloaded content for playback and through an output device.

The embodiment illustrated in FIG. 9 shows that the PC Client software can receive 128 files from various sources such as a private user in box 104, or browse 136 through other sources such as a server player library 74 or a self-help creator library 72, as explained above, and then manage 130 the files and audio locally for immediate playback to the output device based on the Client-to-Pillow Player preferences 132. In the server-to-client download preferences 128, the user may be able to select preferences as noted above. This may also include downloading from other Internet servers in the public domain 124, using such protocols as HTTP and FTP. Whether those other servers include time sensitive information like headline news, traffic, sports, or weather, or simply non-time-sensitive information like traditional media of songs and books, the content can be downloaded into the client PC device libraries 130 for playback locally as per a set of instructions created by the user selecting his downloading preferences. Timing of downloads and distribution to the proximity antenna 42 may be controlled to certain times using an internal clock 134.

It is within the present embodiment that when files are downloaded, they are marked as “new” and once played back from the client PC device to the output device, the file's “new mark” is removed. This enables the client device to track all new items in the library and give priority to the new files in the listening order if so selected in the client to pillow player preferences 132.

In the client-to-pillow player preferences a user can select all her preferences for listening, including for example, setting up jukebox play lists. This would allow a relative such as a mother for instance, to go into the client preferences and select all the songs she wants her child to hear and in what order. One might also set an auto-bedtime wherein the client device will automatically start playing to the output device at a set bedtime. This allows the mother to motivate the child to go to bed on time so that they will catch their favorite bedtime programming. Another example might be setting auto-wakeup wherein the client device will automatically start playing to the output device at a certain wake-up time. This allows the desired messages to get to the child upon wake-up. Further examples might include setting play-on-demand wherein the play list will begin executing upon a user command to start playing; playing new material first which allows the device to first play all “new” files before executing the traditional play list; setting duration of play which allows one to determine how long the client device will output signal to the output device before going into sleep mode and stop sending audio signal; or setting different play options such as “random” wherein files will be played in random order, or “repeat” where a file is re-played over and over, or “complete” wherein all files in the library are played in lieu of a time duration.

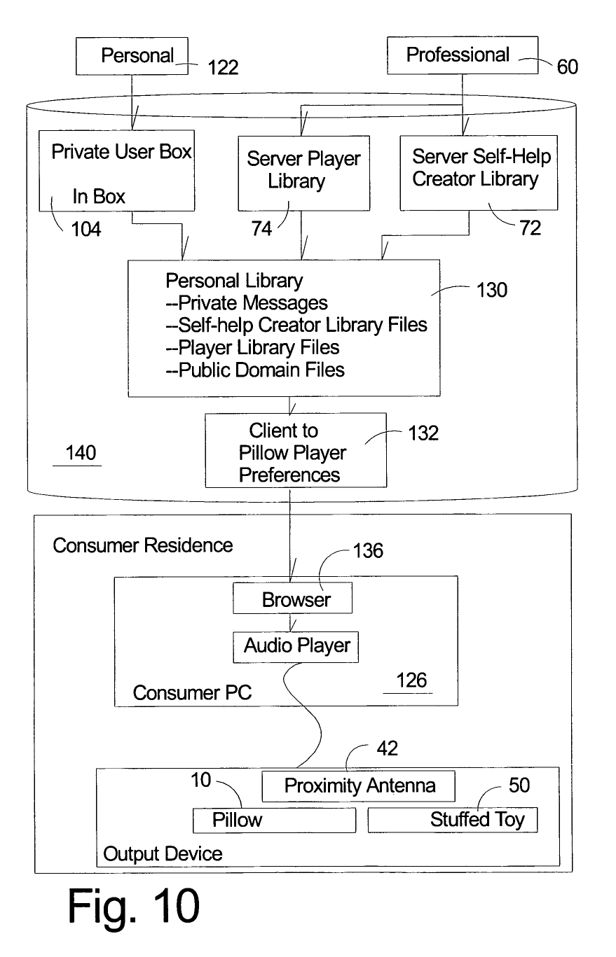

A system network architecture 138 of FIG. 10 is similar in function to the system architecture of 118, and like numerals are used in both figures. The main difference is that in the embodiment of FIG. 9 content and preference are managed on the local level in the PC 126 while in the embodiment of FIG. 10, the content and preferences are stored and managed at the server 140 and the PC 126 only receives the streams generated from the server 140.

An embodiment such as displayed in FIG. 10 would enable increased portability of the output device while maintaining access to personal library and preferences. For example in the case where the parents go out of town and the child has to go stay at a relative's house; if the relative has a PC with only a browser and standard player, than the child can access all the files in their personal library to which they have become accustomed, thus easing the transition of having to stay at a relative's house, and increasing their ability to go to sleep.

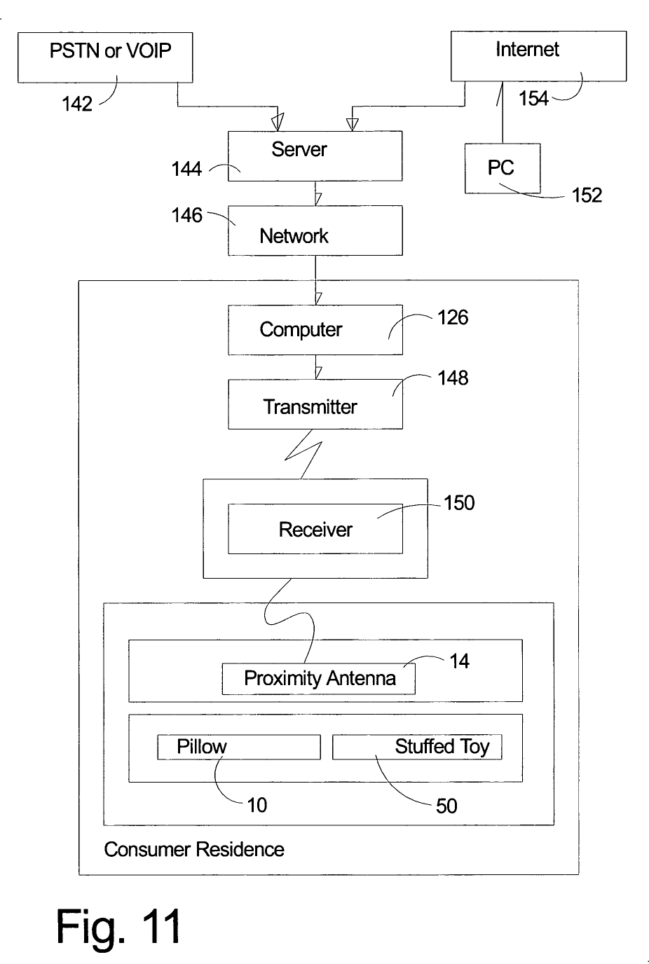

FIG. 11 depicts an embodiment wherein the generator initiates the audio signal into the conduit by means of the PSTN or a VOIP network 142. Initiation can occur in various methods including but not limited to one method of calling a central number (toll-free or not) and logging into the system through dialing in a personal identification code. This will then enable a menu of options including begin recording files on a server 144. Upon completion of the recording session, the user can then access their distribution lists on a subsequent menu option so they can dial in the code for the distribution they wish to send the newly recorded file through a communications network 146. Upon the file being downloaded to the client device or PC 126, the file can be transmitted to the output device by means of a transmitter 148 and receiver 150, which may be linked by various means including but not limited to links of different frequencies and/or modulations. While the preferred embodiment would have the receiver link small and undetectable so as to be placed under the mattress, it is also envisaged that this link could be a wireless computer link (like 802.1x) with a receiving device streaming through the signal to the output device.

FIG. 11 also illustrates a network configuration wherein the generator of the audio initiates the audio file using a readily accessible personal computer 152 and logging into the server 144 through and Internet connection 154 for the uploading and distribution of the file.

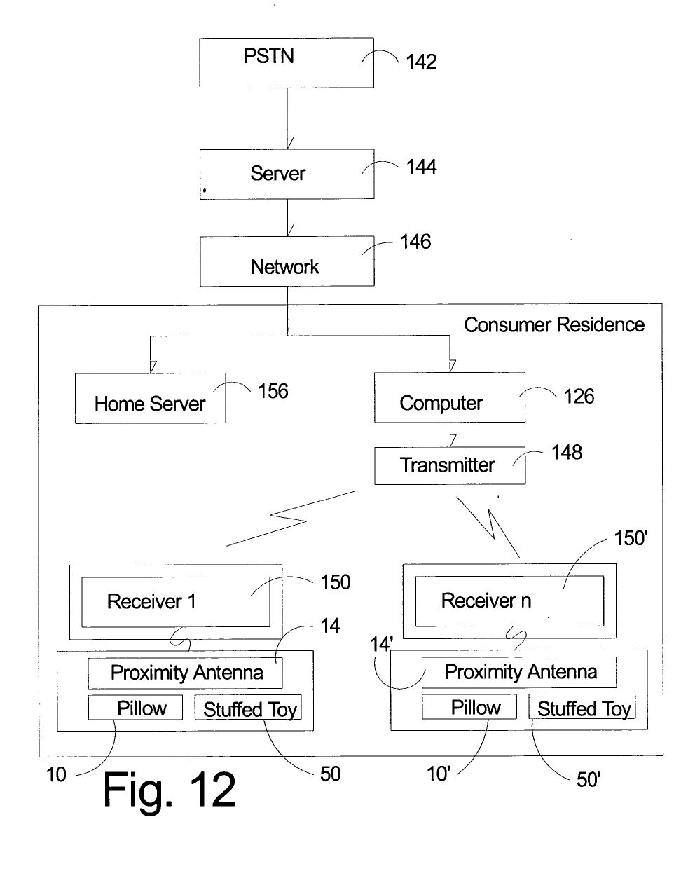

FIG. 12 embodies a case wherein a family with multiple children all wanting to hear the audio signal, can each have their own output device and listen to the audio signal coming from the conduit simultaneously. By the use of multiple receivers 150, 150′ . . . this would be a point to multi-point distribution of the signal at the end of the conduit before handing off the signal to the respective output devices 14,14′ 10, 10′ 50, 50′. This would allow as many as can receive signal from the transmitter to each access the signal and listen to the stories or programming as they go to sleep, wake-up or rest.

Further depicted in FIG. 12 is a server 156 in the local area network of the residence. This in-resident server can free resources of the Internet server 144 by downloading all of the files from the Internet server to the home server, wherein all the PCs in the local area network can access their own libraries on the home server 156 with quicker speeds as well as streaming capabilities.

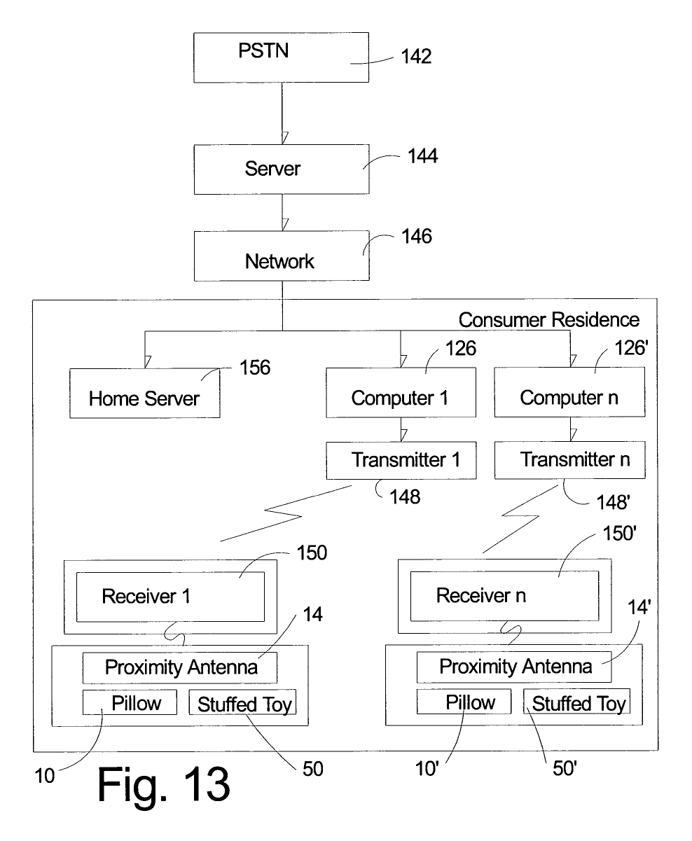

FIG. 13 illustrates an embodiment wherein a family with multiple children all wanting to hear different audio signals, can by having their own playback PC and linking their personal output device to their respective playback device 126, 126′ (personal computer or other playback means) through dedicated transmitters 148, 148′ or channels. This could include one person listening to a television (not shown) while the other person in the same bed or room can be listening to a stream from the Internet or from their own PC. One of the objectives of the present invention is to also allow children and other end users to all listen to their own audio signals, while the rooms or house remains relatively quiet for those persons who would rather go to sleep with quiet. Likewise in the morning, the individualized audio allows the signal to reach the solely intended person without disturbing others in the room or house.

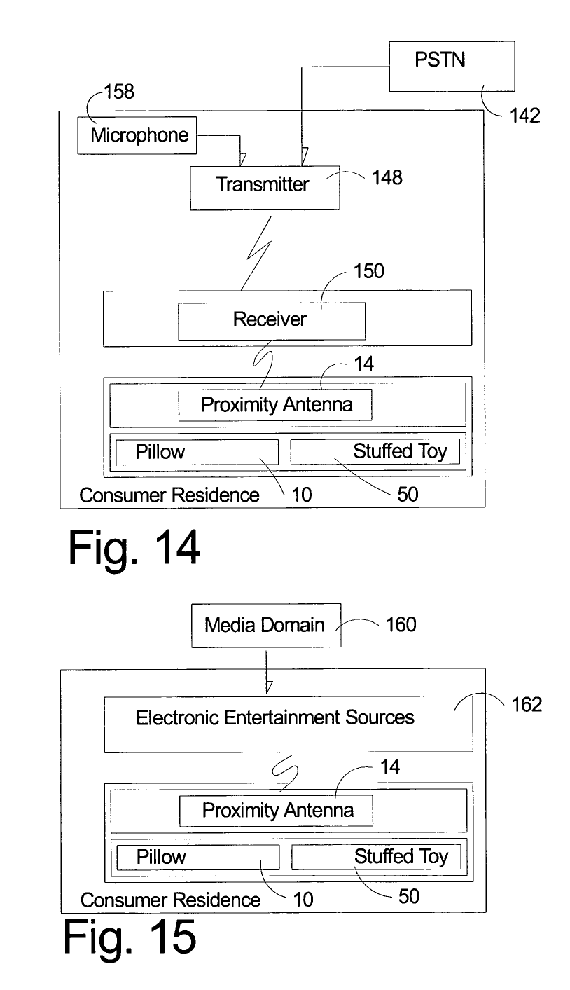

FIG. 14 embodies a real-time audio stream wherein the generator can talk to one or more children in the same residence simultaneously by means of a phone system. In this example a mother could call up a residence where her child is trying to go to sleep. Then once the circuit is established to the residence, the transmitter 148 can be connected to the phone system directly, wherein only the audio from the phone system is transmitted to the output devices. There would be no 2-way communication. This would allow a real-time connection from the generator of the audio to the listener of the audio. A portable microphone 158 might also be connected through the transmitter 148, either directly or indirectly. This would allow a homemaker the ability to work in the kitchen while telling stories or singing to her children in all their beds throughout the house.

FIG. 15 depicts the traditional methodologies of transporting audio signals to end listener wherein the audio signal from a media domain 160 can come from a variety of electronic entertainment sources 162 such as broadcasting methods such as television, radio, or internet streaming, or through “sneaker net” methods where audio is purchased in packets at stores and carried to the residence, or through downloading methods such as peer-to-peer audio sharing methods, or other MP3 format transferring of files. In these cases as well in the other cases, the output device can be connected directly to the electronic entertainment sources 162 using hard wire link or extended through a transmitter and receiver link. What is claimed is:

1. An integrated, one-way audio delivery system comprising:
a generator for initiating an audio signal;
a delivery conduit for routing said signal; and
an output device remote from both the generator and the conduit, comprising a speaker, a passive receiver antenna connected to said speaker, a proximity antenna in communication with said receiver antenna within a designed range, the proximity antenna comprising a connection to said conduit.

2. The system of claim 1 wherein said generator is a professional content provider.

3. The system of claim 1 wherein said generator is non-professional content provider.

4. The system of claim 1 wherein the conduit comprises an internet site for storing said audio signal and a consumer computer connected to said site for downloading said audio signal.

5. The system of claim 1 wherein the conduit comprises a local network for receiving said audio signal and a server for storing said audio signal.

6. The system of claim 5 wherein the local network is a PSTN network.

7. The system of claim 5 wherein the local network is a VOIP network.

8. The system of claim 1 wherein the output device is a comfort device.

9. The system of claim 1 wherein the conduit comprises a plurality of transport networks selected from a group of networks consisting of PSTN, VOIP, HTTP, FTP, television, radio, hard-wire, sneakernet, cellular, or WI-FI 802.1x.

10. An integrated, one-way audio delivery system comprising:
a generator for initiating an audio signal;
a delivery conduit for routing said signal; and
an output device remote from both the generator and the conduit, comprising (1) a comfort device which comprises a speaker and a passive receiver antenna connected to said speaker; and (2) a proximity antenna in communication with said receiver antenna within a designed range, the proximity antenna comprising a connection to said conduit.

11. The system of claim 10 wherein the generator is selected from a group consisting of a related individual, a professional individual, an internet site, a radio broadcast, a television broadcast, an mp3 player, and a cd.

12. The system of claim 10 wherein the comfort device is selected from a group consisting of a pillow, doll, stuffed animal, headrest, or action figure.

13. The system of claim 10 wherein the comfort device further comprises a plurality of speakers.

14. The system of claim 10 wherein the comfort device includes an amplifier.

15. The system of claim 10 wherein the comfort device is a durable pillow capable of withstanding repeated abuse.

16. A method of delivering audio content at a specified time and location comprising:
generating an audio signal at a first location and at time 1 transmitting said signal through a series of conduits;
receiving said audio signal from said conduits at a second location at time 2 through a passive antenna system.

17. The method of claim 16 wherein time 1 equals time 2.

18. The method of claim 16 wherein time 1 precedes time 2.

19. The method of claim 16 wherein the transmitting step includes a conduit that comprises a plurality of transport networks selected from a group of networks consisting of PSTN, VOIP, HTTP, FTP, television, radio, or hard-wire, sneakernet, cellular, or WI-FI 802.1x.

20. The method of claim 16 wherein the generating step utilizes audio content derived from a related individual, a professional individual content provider, an internet site, a radio broadcast, a television broadcast, an mp3, and a compact disk.
